(19) United States
(12) Patent Application Publication
(10) Pub. No.: US 2013/0064560 A1
(43) Pub. Date: Mar. 14, 2013

(54) IMAGE FORMING APPARATUS HAVING STABLE IMAGE DENSITY

(71) Applicant: Jun Hirabayashi, Yokohama-shi (JP)

(72) Inventor: Jun Hirabayashi, Yokohama-shi (JP)

(73) Assignee: CANON KABUSHIKI KAISHA, Tokyo (JP)

(21) Appl. No.: 13/697,703

(22) PCT Filed: May 13, 2011
(86) PCT No.: PCT/JP2011/061592

§ 371 Date: Nov. 13, 2012

(30) Foreign Application Priority Data
May 18, 2010 (JP) 2010-114471

(51) Int. Cl. G03G 15/08; G03G 15/22

(52) U.S. Cl. 399/44; 399/49; 399/60

(57) ABSTRACT

An image forming apparatus capable of performing both of stabilization of image density on a short-term basis and that on a long-term basis in a compatible manner. A CPU predicts an amount of electrostatic charge of toner particles in a developer container, sets a potential forming condition for image creation, and forms a toner image to be fixed on a recording medium, on a photosensitive drum according to the set potential forming condition. The CPU forms a pattern image for controlling a toner replenishment amount, on the photosensitive drum, under a potential forming condition which is set independently of the potential forming condition for image creation, and controls the amount of toner to be supplied to the developer container such that density of the pattern image, detected by an optical sensor, becomes equal to a target density.

### TECHNICAL FIELD

The present invention relates to an image forming apparatus that performs image formation by electrophotography.

### BACKGROUND ART

Conventionally, there has been known an image forming apparatus that performs image formation by electrophotography. This apparatus electrically charges toner particles and performs image formation using electrostatic force. Therefore, when the amount of electrostatic charge of toner particles changes, the density and quality level of an output image changes accordingly. The amount of electrostatic charge of toner particles largely varies with the usage environment, the density of an image to be output, output elapsed time, etc. Therefore, unless some kind of effective control is executed for stabilizing the output, the output image changes depending on various kinds of conditions.

In an electrophotographic image forming apparatus using a two-component development unit, i.e. in an image forming apparatus that performs image formation using toner particles and carrier particles as a developer, toner replenishment is performed such that an amount of toner is supplied which is substantially equal to a consumed toner amount predicted from image data. Further, restricted supply or adjusted supply of toner is also generally performed using the value of output from an inductance sensor (magnetic permeability sensor) that measures concentration of toner particles in the developer based on the difference in magnetic permeability between the toner particles and the carrier particles in the developer.

In a two-component development unit, in general, the amount of electrostatic charge of toner particles varies with a mixture ratio (T/C ratio) between toner particles and carrier particles in the development unit, and as the T/C ratio becomes smaller, the amount of electrostatic charge of toner particles increases. When the amount of electrostatic charge of toner particles increases, the amount of toner particles attached to a latent image having a certain amount of charges decreases, whereas when the amount of electrostatic charge of toner particles decreases, the amount of toner particles attached to the latent image having the certain amount of charges increases.

Therefore, the amount of toner particles to be replenished is adjusted to thereby control the mixture ratio between toner particles and carrier particles in the development unit. This makes it possible to stabilize the amount of electrostatic charge of toner particles and the output image density.

To this end, feedback control is generally widely performed in which an image patch (pattern image) is output and a toner replenishment amount is controlled based on patch density (toner amount) measured on an image bearing member, a transfer member, or the like, such that the output density of the image patch becomes closer to a target density. That is, in addition to the adjustment of the toner replenishment amount according to image data and the adjustment of the toner replenishment amount based on the output value from the inductance sensor, toner replenishment control is widely performed in which the toner replenishment adjustment amount calculated based on the density of the image patch is taken into account. This adjusts the amount of toner electrostatic charge and the toner density.

However, the control of stabilizing the output image density by the above-mentioned toner replenishment amount adjustment based on the output density of the image patch is feedback control that performs various adjustments after measuring the patch density (toner amount). Therefore, it is not possible to prevent dead time in control (time delay in control) from being generated. Further, there is also a time delay before the toner replenishment amount adjustment is reflected on a change (follow-up) in the amount of electrostatic charge of toner particles, which makes the time delay in control unavoidable, causing a density deviation at a short period.

To solve such a problem, there has been proposed a technique, e.g. in Patent Literature 1, for stabilizing image density by performing feedforward control in which an amount of electrostatic charge of toner particles is estimated, and a contrast potential in image formation is controlled on a real-time basis.

### CITATION LIST

### Patent Literature

PTL 1: Japanese Patent Laid-Open Publication No. 2001-42613

### SUMMARY OF INVENTION

### Technical Problem

The feedforward control in the above-mentioned conventional apparatus has an advantageous effect of reducing variation in the amount of electrostatic charge of toner particles. However, the above-mentioned feedforward control interferes with an operation of the toner replenishment amount feedback control for maintaining the amount of electrostatic charge of toner particles at a constant amount on a long term basis, and as a result, this sometimes causes a problem that the stable output image density cannot be obtained. Hereafter, a description will be given of an example of such a problem.

Image creation is performed using an electrostatic force in the electrophotographic technology, so that it is preferable that the amount of electrostatic charge of toner particles varies as little as possible. However, for example, when an image forming potential contrast is adjusted based on a result of prediction of the amount of electrostatic charge of toner particles, the output density is maintained in theory at a substantially constant level, irrespective of the value of the amount of electrostatic charge of toner particles. Although in a strict sense, there occurs variation in the output density caused by a prediction error or the like, the output density is constant except the variation.

Under such conditions, the density of the image patch is also maintained at a substantially constant level as desired, and hence correction of the toner replenishment amount in the toner replenishment amount control based on the image patch is hardly performed. As a result, in the toner replenishment amount control, only toner replenishment according to a target amount of toner for development is performed, so that the toner density in the developer is maintained at a substantially constant value. Therefore, the adjustment of the toner replenishment amount based on the patch density is substantially not performed.

Therefore, even if the amount of toner for development for the image bearing member is optimized, the following transfer process and so on may not be properly carried out depending on the amount of electrostatic charge of toner particles. For example, to properly perform the transfer operation, it is necessary that the amount of electrostatic charge of toner particles is appropriate. In the control described in Japanese Patent Laid-Open Publication No. 2001-42613, the image density is adjusted by controlling the contrast potential in image formation on a real-time basis by the feedforward control according to predicted variation in the amount of electrostatic charge of toner particles. Therefore, when the amount of electrostatic charge of toner particles becomes insufficient or excessive, the transferability changes, which degrades the image in density and quality level.

Therefore, from the point of view of stabilization of image density on a short-term basis and on a long-term basis, there is room for improvement.

The present invention provides an image forming apparatus which is capable of performing stabilization of image density both on a short-term basis and on a long-term basis in a compatible manner.

### Solution to Problem

Accordingly, in a first aspect of the present invention, there is provided an image forming apparatus that performs image formation by electrophotography, comprising a predicting unit configured to predict an amount of electrostatic charge of toner particles in a developer container, a setting unit configured to set a potential forming condition for image creation, an image creation unit configured to form a toner image to be fixed on a recording medium, on an image bearing member, according to the potential forming condition set by the setting unit, a forming unit configured to form a pattern image for controlling a toner replenishment amount of toner to be supplied to the developer container for replenishment, on the image bearing member, under a potential forming condition which is set independently of the potential forming condition set by the setting unit for image creation, a detection unit configured to detect density of the pattern image formed by the forming unit, and a control unit configured to control the toner replenishment amount of toner to be supplied to the developer container such that the density of the pattern image, detected by the detection unit, becomes closer to a target density, wherein the setting unit sets the potential forming condition for image creation based on a result of prediction by the predicting unit such that density of the toner image formed by the image creation unit becomes constant.

Accordingly, in a second aspect of the present invention, there is provided an image forming apparatus that performs image formation by electrophotography, comprising a predicting unit configured to predict an amount of electrostatic charge of toner particles in a developer container, an image creation unit configured to form a toner image to be fixed on a recording medium, on an image bearing member, a correction unit configured to perform gradation correction when the toner image is formed by the image creation unit, a forming unit configured to form a pattern image for controlling a toner replenishment amount of toner to be supplied to the developer container for replenishment, on the image bearing member, while performing gradation correction which is not dependent on a result of prediction by the predicting unit, a detection unit configured to detect density of the pattern image formed by the forming unit, and a control unit configured to control the toner replenishment amount of toner to be supplied to the developer container such that the density of the pattern image, detected by the detection unit, becomes closer to a target density, wherein the correction unit performs the gradation correction based on the result of the prediction such that the density of the toner image formed by the image creation unit becomes constant.

### Advantageous Effects of Invention

According to the present invention, it is possible to perform both of stabilization of image density on a short-term basis and that on a long-term basis in a compatible manner.

The features and advantages of the present invention will become more apparent from the following detailed description taken in conjunction with the accompanying drawings.

### BRIEF DESCRIPTION OF DRAWINGS

FIG. 1 is an overall schematic view of an image forming apparatus according to a first embodiment of the present invention.

FIG. 2 is a flowchart of a basic operation control process in the present embodiment.

FIG. 3 is a flowchart of a toner replenishment adjustment amount feedback control process executed in a step of the basic operation control process in FIG. 2.

FIG. 4 is a control diagram of the toner replenishment adjustment amount feedback control process.

FIG. 5 is a flowchart of an image exposure intensity correction control process based on the prediction of an amount of electrostatic charge of toner particles.

FIG. 6 is a control diagram in image formation.

FIG. 7 is a flowchart of an image exposure intensity correction control process based on the prediction of an amount of electrostatic charge of toner particles, which is executed by an image forming apparatus according to a second embodiment.

FIG. 8 is a flowchart of a gradation correction control process based on the prediction of an amount of electrostatic charge of toner particles, which is executed by an image forming apparatus according to a third embodiment.

FIG. 9A illustrates an example of a case where an output value of a gradation conversion table is reduced by the gradation correction.

FIG. 9B illustrates an example of a case where the output value of the gradation conversion table is increased by the gradation correction.

### DESCRIPTION OF EMBODIMENTS

The present invention will now be described in detail below with reference to the accompanying drawings showing embodiments thereof.

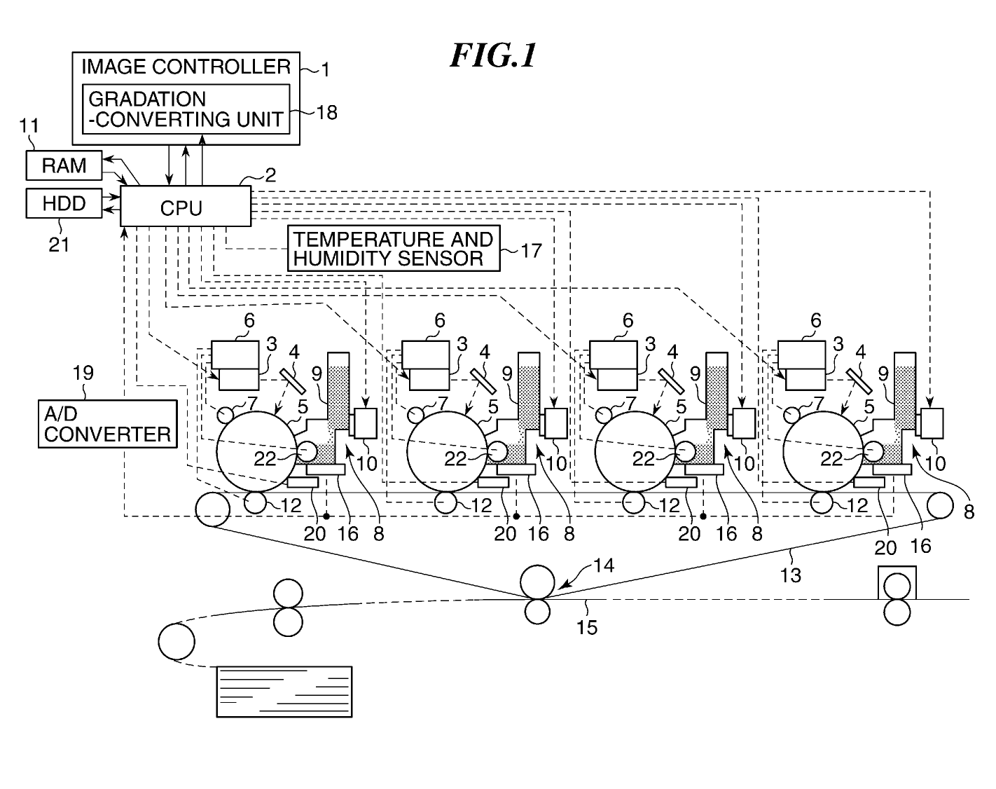

FIG. 1 is an overall schematic view of an image forming apparatus according to a first embodiment of the present invention.

This image forming apparatus is a tandem-type image forming apparatus that performs image formation by electrophotography, and for example, is configured as a printer. The image forming apparatus includes four image forming sections, and each of them has the same configuration. Therefore, a description will be mainly given of one of them.

The image forming apparatus comprises a CPU (predicting unit, setting unit, forming unit, control unit, and correction unit) 2 that controls overall operations of the image forming apparatus, an image controller 1, a RAM 11, an HDD (hard disk drive) 21, and an A/D converter 19. Further, the main unit of the image forming apparatus includes a temperature and humidity sensor 17 and a timer, not shown. The image controller 1 includes a gradation-converting unit 18 provided therein.

Each image forming section includes a photosensitive drum (image bearing member) 5, a laser driver (hereinafter referred to as “the LD driver”) 3, a reflective mirror 4, an electrostatic charger (charging roller) 7, a development device 8, a primary transfer device 12, and so on. The development device 8 is a two-component development unit including a developer container 9 for storing developer containing toner and carrier. The development device 8 includes not only a development roller 22 as a developer bearing member which carries developer thereon, but also a T/C ratio-detecting sensor 16, and an optical sensor (detection unit) 20. The CPU 2, and the charging roller 7, the LD driver 3, the development device 8, and so on controlled by the CPU 2 form “an image creation unit”.

The image controller 1 receives an electric signal representative of image information described in a specific description language from a host computer or the like, not shown, (hereinafter referred to as “the PC”), and creates image data. Based on the created image data, the CPU 2 performs signal processing for creating a latent image by the LD driver 3, and delivers a signal therefor to the LD driver 3. In the LD driver 3, the delivered signal is converted to an optical signal, and the converted optical signal is irradiated to a polygon mirror attached to a polygon motor (not shown) which is rotated at a high speed. The irradiated optical signal is reflected by the polygon mirror, and is irradiated by the reflective mirror 4 onto a surface of the photosensitive drum 5 as a latent image bearing member.

The photosensitive drum 5 is uniformly electrically charged to a constant potential by the charging roller 7 controlled to a voltage value by a high-voltage output section 6 as a bias-applying unit which is a high-voltage power supply. The photosensitive drum 5 is irradiated with light (exposed to the light), whereby the potential at irradiated portions is changed, and as a result, an electrostatic latent image is formed on the photosensitive drum 5.

The present image forming apparatus has a mechanism that electrically charges the photosensitive drum 5 to a negative potential and toner particles to a negative potential, performs light irradiation on the photosensitive drum 5, and then causes toner particles to be attached to portions where the electrical potential is changed by the light irradiation (bright portions). Further, the photosensitive drum 5 is in a state electrically charged to the constant potential using the charging roller 7 before the light irradiation, and hence the electrical potential in the bright portions where toner is developed is varied with the light intensity of the light irradiated from the LD driver 3. That is, the amount of toner for development can be adjusted by controlling the amount of light irradiation to the photosensitive drum 5.

The development device 8 attaches only toner contained in the developer onto the photosensitive drum 5 by the development roller 22 to put (develop) the electrostatic latent image formed on the photosensitive drum 5 into a real and visual form as a toner image. The CPU 2 rotates a toner replenishing motor 10 to thereby replenish toner into the developer container 9, as required. The CPU 2 holds a record of the toner replenishment amount within a predetermined time period in the RAM 11.

A development bias which is controlled by the high-voltage output section 6 is applied to the development roller 22. The toner image formed by development on the photosensitive drum 5 is transferred onto an intermediate transfer belt 13 by the primary transfer device 12, and then is further transferred onto a surface of a recording medium 15, such as paper, by a secondary transfer device 14. The T/C ratio-detecting sensor 16 measures a mixture ratio between toner particles and carrier particles in the developer container 9. A value output from the T/C ratio-detecting sensor 16 is loaded into the CPU 2 via the A/D converter 19 at a required timing.

The recording medium 15 to which the toner image is transferred is conveyed by conveying rollers, and the transferred toner image is permanently fixed on the recording medium 15 by a fixing device. Then, the recording medium 15 is conveyed out of the image forming apparatus.

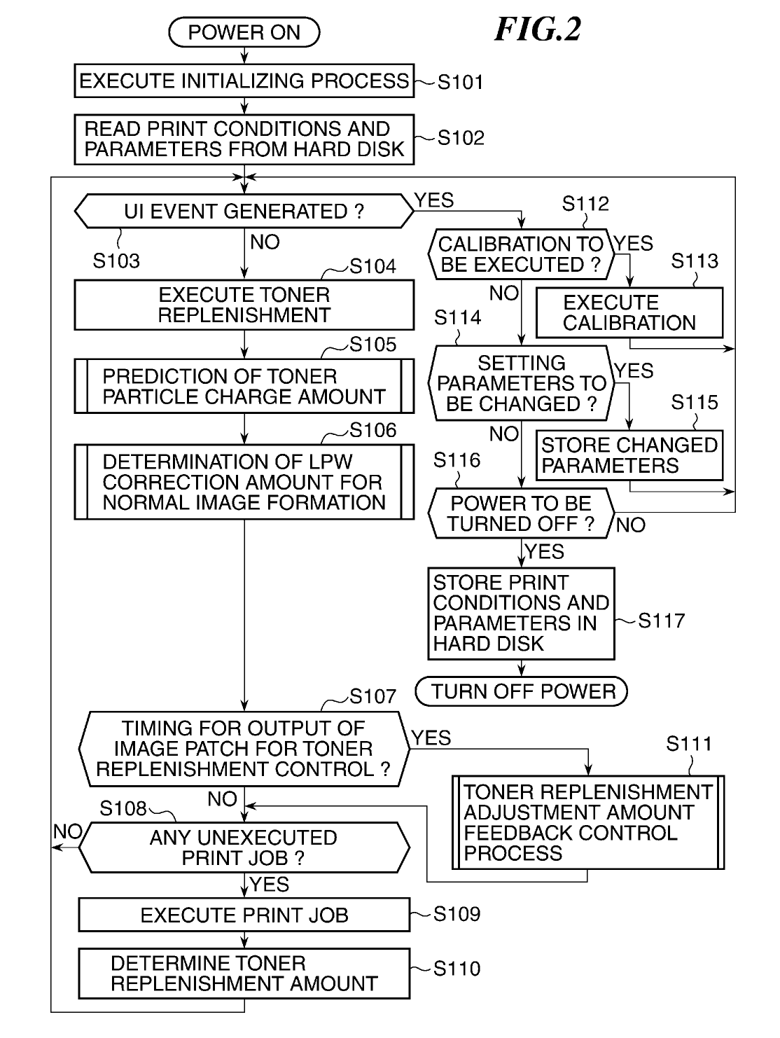

FIG. 2 is a flowchart of a basic operation control process executed by the image forming apparatus according to the present embodiment.

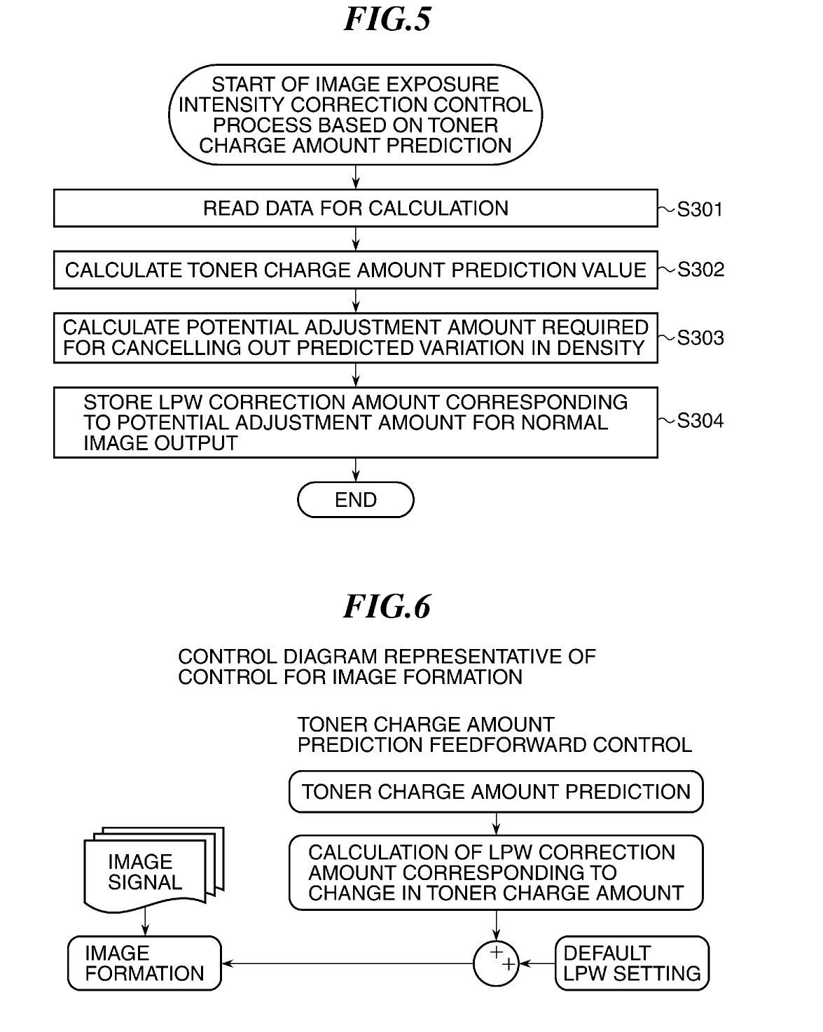

The outline of the basic operation control process will be explained. An amount (toner charge amount) of electrostatic charge of toner particles contained in the developer container 9 is predicted. Based on a result of the prediction, a condition for potential formation is set such that the density of a toner image for a normal image to be formed by development on the photosensitive drum 5 becomes constant (steps S105 and S106, and FIGS. 5 and 6). Therefore, normally, i.e. in a step S107, referred to hereinafter, unless it is determined that it is timing for output of a patch for the toner replenishment control, feedforward control for reducing variation in the amount of electrostatic charge of toner particles is executed.

In the present embodiment, exposure intensity is set as an example of a potential forming condition. However, the potential forming condition is not limited to this, but it may be a setting of a charge bias or a setting of a developing bias, or may be a combination of these settings. Further, the object to be predicted is not limited to the toner charge amount, but it may be a more direct object, such as output image density or development toner density.

On the other hand, in the present embodiment, an amount of toner with which the developer container 9 is to be replenished is basically determined such that the toner replenishment amount becomes equal to a toner consumption amount calculated from the image data. However, in addition to that, for the purpose of stabilization of development properties and transferability, the adjustment of the toner replenishment amount (determination of a toner replenishment adjustment amount) is performed from a viewpoint of adjusting the amount of electrostatic charge of toner particles to a constant amount.

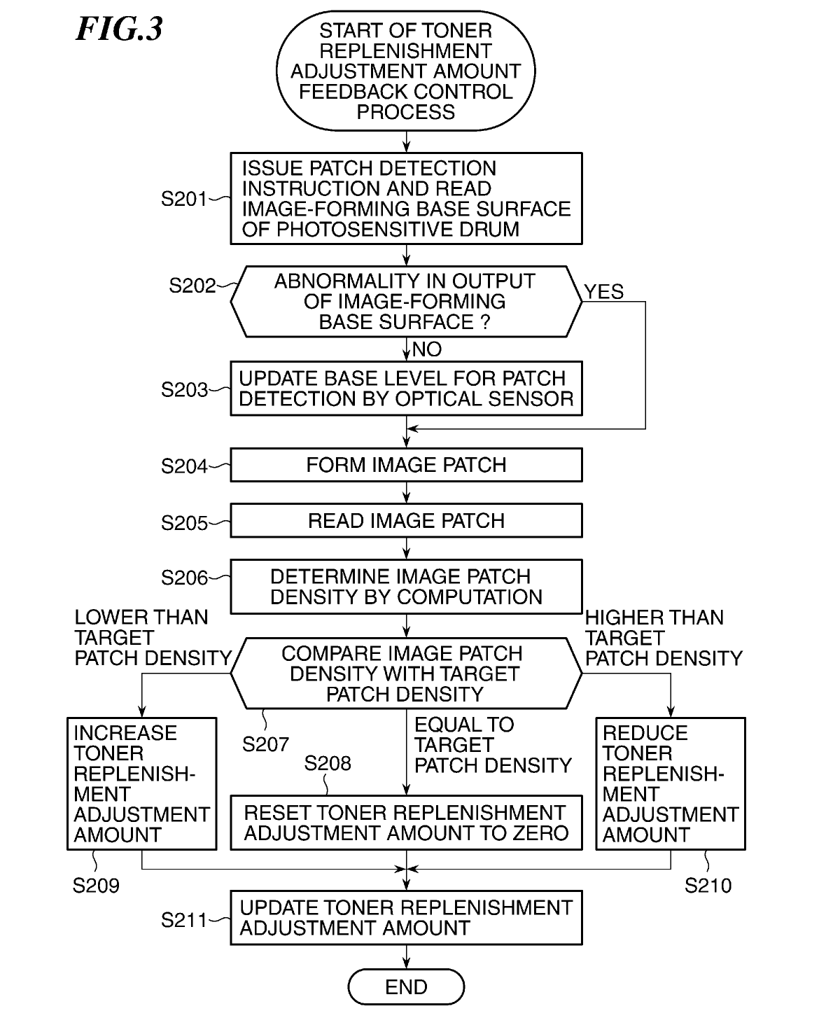

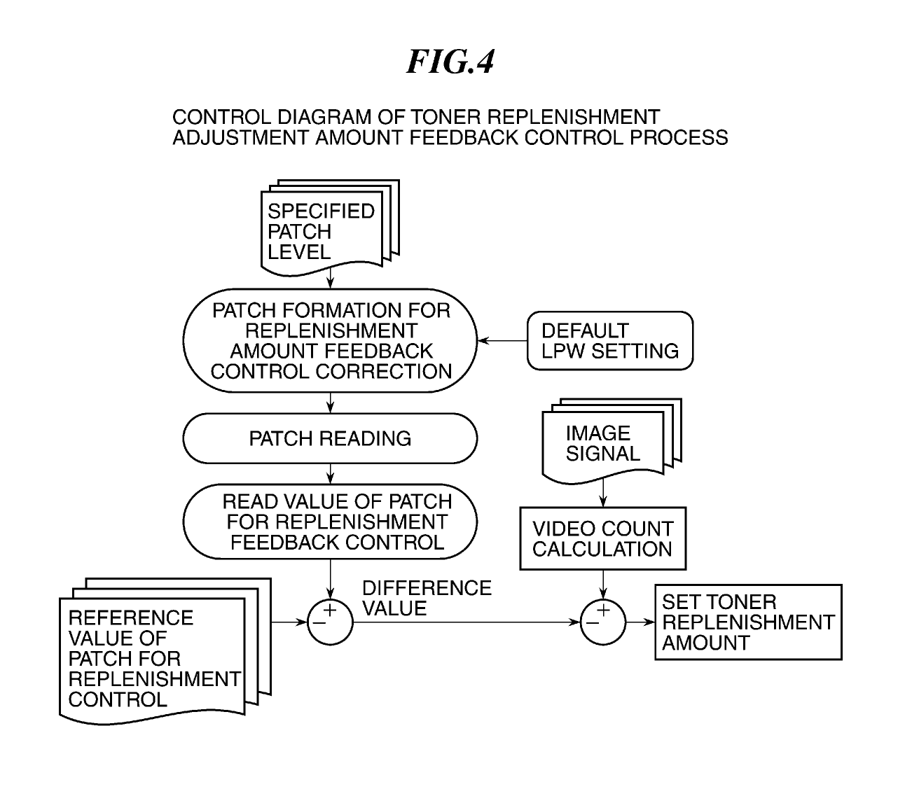

That is, after setting a proper potential contrast condition (potential forming condition) based on a value detected by the temperature and humidity sensor 17, a latent image of an image patch (pattern image) for controlling the toner replenishment amount is formed on the photosensitive drum 5 under the set potential contrast condition. Then, the optical sensor 20 detects (measures) image density of the image patch formed by developing the latent image. Then, based on the patch density (toner amount) calculated from the detection result, the toner replenishment adjustment amount is feedback-controlled such that the output density of the image patch becomes closer to a target density (step S111 in FIG. 2, and FIGS. 3 and 4). In other words, under a predetermined condition, a toner replenishment adjustment amount feedback control is executed.

Here, the above-mentioned “toner image for a normal image” is a toner image which is to be fixed on the recording medium 15, and does not include “an image patch for controlling the toner replenishment amount”. The potential forming condition for a toner image for a normal image is set based on a result of prediction of the amount of electrostatic charge of toner particles, whereas the potential forming condition for an image patch is set based on a value detected by the temperature and humidity sensor 17, and does not depend on the above-mentioned prediction result. Therefore, these two types of potential forming conditions are independently set.

The process in FIG. 2 is started when the power of the apparatus main unit is turned on. First, the CPU 2 executes an initializing process (step S101), and reads printing conditions and parameters from the HDD 21 into the RAM 111 (step S102). Next, in a step S103, the CPU 2 determines whether or not a user-interface (UI) event is generated. The user-interface event is generated by inputting of an instruction by a user from a console section, not shown.

Then, if a user-interface event is generated, the CPU 2 executes processing associated with the generated user-interface event. That is, the CPU 2 determines in a step S112 whether or not the user-interface event is an instruction for executing calibration. If it is determined that the user-interface event is an instruction for executing calibration (YES to the step S112), the CPU 2 executes calibration (step S113) and then returns the process to the step S103, whereas if not, the CPU 2 proceeds to a step S114, wherein it is determined whether or not the user-interface event is an instruction for changing a configuration parameter. If it is determined that the user-interface event is an instruction for changing a configuration parameter (YES to the step S114), the CPU 2 changes the configuration parameter and stores the changed parameter in the RAM 11 (step S115). Thereafter, the CPU 2 returns the process to the step S103. On the other hand, if it is determined that the user-interface event is not an instruction for changing a configuration parameter (NO to the step S114), the CPU 2 proceeds to a step S116, wherein it is determined whether or not the user-interface event is an instruction for turning the power off. If it is determined that the user-interface event is an instruction for turning the power off (YES to the step S116), the CPU 2 reads out the printing conditions and parameters from the RAM 111 and stores the same in the HDD 21 (S117), and then turns off the power of the apparatus, followed by terminating the present process. If it is determined that the user-interface event is not an instruction for turning the power off (NO to the step S116), the CPU 2 returns the process to the step S103.

If it is determined in the step S103 that no user-interface event is generated, the CPU 2 executes toner replenishment (step S104). In this step, an amount of toner is replenished which is determined by the immediately preceding execution of a step S110, referred to hereinafter. Next, the CPU 2 executes a process for predicting the amount of electrostatic charge of toner particles contained in the developer container 9 (step S105), and a process for determining an exposure intensity (hereinafter referred to as the “laser power” or “LPW”) correction amount for normal image formation (step S106). These processes will be described hereinafter with reference to FIGS. 5 and 6. The laser power correction amount determined in the step S106 is only applied to toner image formation for a normal image, and is not applied to image patch formation.

Next, the CPU 2 determines whether or not it is timing of output of the image patch for toner replenishment control (step S107), and if it is determined that it is the timing (YES to the step S107), the CPU 2 executes the toner replenishment adjustment amount feedback control process (step S111), and then proceeds to a step S108. On the other hand, when it is not the timing (NO to the step S107), the CPU 2 directly proceeds to the step S108 without executing the toner replenishment adjustment amount feedback control.

In the step S108, the CPU 2 determines whether or not there is a print job which has not been executed, and if there is no unexecuted print job (NO to the step S108), the CPU 2 returns to the step S103, whereas if there is an unexecuted print job (YES to the step S108), the CPU 2 executes the print job (step S109). During execution of the print job, the laser power correction amount in the normal image formation, which is determined in the step S106, is reflected.

By the way, a gradation conversion table is stored in the HDD 21, and is read out into the RAM 11 for reference. In the present embodiment, conversion processing using the gradation conversion table is also executed in combination with each of normal image formation by a print job and image patch formation.

Next, in the step S110, the CPU 2 determines the toner replenishment amount. In this step, an amount obtained by adding a correction amount determined in the step S111 (i.e. toner replenishment adjustment amount) to the toner consumption amount is determined as the toner replenishment amount. Thereafter, the CPU 2 returns the process to the step S103.

FIG. 3 is a flowchart of the toner replenishment adjustment amount feedback control process executed in the step S111 in FIG. 2. FIG. 4 is a control diagram of the toner replenishment adjustment amount feedback control process.

First, in FIG. 3, the CPU 2 issues a patch detection instruction for execution of image patch formation and density detection, and reads an image-forming base surface of the photosensitive drum 5 as an image bearing member (step S201). Next, the CPU 2 determines whether or not there is an abnormality in an output of the read image-forming base surface (step S202). As a result of the determination, if there is no abnormality (NO to the step S202), the process proceeds to a step S204, whereas if there is an abnormality (YES to the step S202), the CPU 2 updates a base level of the optical sensor 20 for detecting density of an image patch (step S203), and then the process proceeds to the step S204.

In the step S204, the CPU 2 forms an image patch based on the image data associated with a specified patch level (see FIG. 4). In doing this, the photosensitive drum 5 is exposed under the potential contrast condition (default LPW setting in FIG. 4) set based on the value detected by the temperature and humidity sensor 17.

Next, when the optical sensor 20 detects (measures) a density of the image patch (see FIG. 4), the CPU 2 receives the detection result (step S205), and determines the density of the image patch from the detection result by computation (step S206).

Next, the CPUS 2 compares the measured patch density determined by computation and a target patch density (target density), and determines a difference value between the measured patch density and the target patch density (step S207). The difference value determined in this step is a value obtained by subtracting the target patch density (patch reference value for the replenishment control, referred to hereinafter, in FIG. 4) from the measured patch density (replenishment feedback patch read value, referred to hereinafter, in FIG. 4). It is assumed that as the density is higher, the patch density indicates a larger value.

Then, the CPU 2 increases or decreases the toner replenishment adjustment amount based on a result of comparison between the measured patch density and the target patch density. More specifically, when the measured patch density is lower than the target patch density (the difference value is smaller than 0), the CPU 2 increases the toner replenishment adjustment amount (step S209). On the other hand, when the measured patch density is higher than the target patch density (the difference value is larger than 0), the CPU 2 decreases the toner replenishment adjustment amount (step S210). Further, when the measured patch density is equal to the target patch density (the difference value is equal to 0), the CPU 2 resets the toner replenishment adjustment amount to 0 (step S208).

After execution of one of these steps, the CPU 2 proceeds to a step S211, wherein the CPU 2 updates the current toner replenishment adjustment amount to the toner replenishment adjustment amount set in one of the steps S208 to 210, and stores the updated toner replenishment adjustment amount in the RAM 11. As mentioned hereinabove, in the step S110 in FIG. 2, the amount obtained by adding the toner replenishment adjustment amount updated in the step S211 to the toner consumption amount is determined as the toner replenishment amount. As shown in FIG. 4, the toner consumption amount is calculated by a video counter calculation from the image signal, and the above-mentioned difference value is added to the calculated toner consumption amount. It should be noted that although the amount increased in the step S209 or decreased in the step S210 in FIG. 3 is set to be dependent on the difference value, it may be a fixed amount.

By the way, the amount of electrostatic charge of toner particles varies with the T/C ratio. As the ratio of the amount of toner particles to the amount of carrier particles becomes smaller, the amount of electrostatic charge of toner particles increases. When the amount of electrostatic charge of toner particles increases, the amount of toner particles attached to a certain latent charge image decrease, and inversely, when the amount of electrostatic charge of toner particles decreases, the amount of toner particles attached to the certain latent charge image increases.

The above-described toner replenishment adjustment amount feedback control process is executed for controlling the toner replenishment amount such that the amount of toner for development becomes constant with respect to a predetermined potential latent image, to thereby change the mixture ratio (T/C ratio) between toner particles and carrier particles in the developer container 9. By controlling the toner replenishment amount such that the measured patch density becomes closer to the target patch density, the amount of electrostatic charge of toner particles converges to a desired amount. This makes it possible to maintain the toner charge amount at a constant value on an averaged time-basis, i.e. on a long-term basis.

In addition to the above toner replenishment adjustment amount feedback control process, to prevent toner particles from being scattered and carrier particles from attaching to the photosensitive drum 5, the CPU 2 performs control based on the output from the T/C ratio-detecting sensor 16 such that the T/C ratio is accommodated within certain upper and lower limits.

By the way, the toner replenishment adjustment amount feedback control process is just a feedback control process, and hence it is not possible to prevent occurrence of a time delay due to a disturbance, so that a certain degree of short-term density deviation is caused. To prevent such a problem, in the present embodiment, the potential forming condition in the normal image formation is controlled based on the prediction (estimation) of the toner charge amount (or output image density), whereby the short-term density variation is also reduced which cannot be sufficiently compensated for by the toner replenishment adjustment amount feedback control process. This realizes both of stabilization of “the amount of toner for development” and stabilization of “the amount of electrostatic charge of toner particles”, which makes it possible to obtain stability of the image density and quality level both on a short-term basis and on a long-term basis.

FIG. 5 is a flowchart of an image exposure intensity correction (feedforward) control process based on the prediction of the amount of electrostatic charge of toner particles. The present process corresponds to the steps S105 and S106 in FIG. 2. FIG. 6 is a control diagram representative of control for image formation (particularly for normal image formation).

In the image exposure intensity correction control process, the toner charge amount is predicted at intervals of a predetermined time period (for each time step). To this end, the CPU 2 causes a toner consumption amount, a toner replenishment amount, and a toner amount in the developer container 9 in each time period to be stored in the RAM 11. For data items of the toner consumption amount and the toner replenishment amount which are stored, there are employed data of values averaged over time periods in respective time steps.

First, in a step S301 in FIG. 5, the CPU 2 reads data for calculating a prediction value of the amount of electrostatic charge of toner particles. This data includes data accumulated from the last calculation, the toner consumption amount, the toner replenishment amount, and so on. Next, the CPU 2 calculates a prediction value of the amount of electrostatic charge of toner particles (step S302). In this step, the prediction value of the amount of electrostatic charge of toner particles is calculated on a time step-by-time step basis, and an equation used for this calculation is switched depending on whether or not the development roller 22 is being rotated. When the development roller 22 is being rotated, the following equation (1) is used for the calculation, whereas when the development roller 22 is not being rotated, the following equation (2) is used for the calculation:

[Math. 1]

amount of electrostatic charge of toner particles (prediction value)=amount of electrostatic charge of toner particles in preceding time step×(1−calculation time step/α−development amount/toner amount in the developer container)+β×calculation time step/α+amount of electrostatic charge of toner particles in preceding calculation (1)

[Math. 2]

amount of electrostatic charge of toner particles (prediction value)=amount of electrostatic charge of toner particles in preceding time step×(1−γ) (2)

In the above equations, the three parameters of α, β, and γ are set in advance according to charging characteristics of toner. α represents a rate of frictional charging (elimination of electrostatic charge) per unit time, β represents a saturated amount of electrostatic charge of toner particles, and γ represents a rate of leakage of charges from toner particles per unit time. An initial value of the amount of electrostatic charge of toner particles is 0.

The “development amount/toner amount in the developer container” in a first term on the right side of the above equation (1) corresponds to “a charge balance between charged toner particles which are developed and uncharged toner particles which are supplied for replenishment”. That is, the “development amount/toner amount in the developer container” corresponds to a reduced amount of electrostatic charge caused by the consumption of toner in the developer container 9 and supply of toner thereto.

Part of the right side of the above equation (1) formed by the second term and the first term except the above-mentioned term therein corresponds to “an amount of change in the electrostatic charge of toner particles caused by frictional charging”. The amounts explained above are added to the preceding amount of electrostatic charge of toner particles represented by the third term on the right side of the above equation (1), whereby the equation for predicting a next amount of electrostatic charge is formed. The above equation (2) shows that the toner particle charge amount decreases at a fixed time constant.

In the present embodiment, by the toner replenishment adjustment amount feedback control process, it is possible to maintain the toner charge amount at a constant amount to a certain degree. However, it is not possible to prevent occurrence of a time delay in the charge amount adjustment caused by disturbances, so that a certain degree of variation in the toner charge amount is caused. To prevent such a problem, in the present embodiment, a deviation or variation in the actual toner charge amount with respect to the predicted toner charge amount, i.e. a predetermined target toner charge amount is estimated (predicted). To cancel out the variation in the density caused by the deviation/variation in the toner charge amount, the exposure intensity of light irradiated from the LD driver 3 for normal image output is feedforward controlled. More specifically, the CPU 2 adjusts the intensity of irradiation (image exposure intensity) of light from the LD driver 3 such that the potential contrast satisfies the following equation (3):

potential contrast at the time of image output=(potential contrast at a reference time/toner particle charge amount predicted at the reference time)×toner particle charge amount predicted at the time of image output [Math. 3]

In this equation, the “reference time” indicates a time at which a calibration operation is executed for color matching, or if it is configured not to execute the calibration operation, a time at which an output defining a color tone reference of an output image is executed, such as a start time of execution of an output job.

More specifically, in a step S303 in FIG. 5, the CPU 2 calculates a potential adjustment amount required to cancel out a predicted density variation. Next, in a step S304, the CPU 2 causes a laser power correction value corresponding to the calculated potential adjustment amount to be stored in the RAM 11 as a laser power correction amount in normal image output (potential forming condition for image creation).

The laser power (LPW) correction amount stored in this step is reflected on normal image formation of the print job in the step S109 in FIG. 2. As shown in FIG. 6, the next normal image formation is performed at the exposure intensity obtained by adding the calculated and stored LPW correction amount to the exposure intensity set by the default LPW setting.

According to the present embodiment, the toner replenishment amount is feedback-controlled such that the density of the image patch becomes closer to the target density, and this makes it possible to stabilize the image density on a long-term basis. Further, there are independently set a potential forming condition for image creation, which is applied when a normal image is formed, and a potential forming condition for control of the toner replenishment amount, which is applied when an image patch is formed. Further, a toner particle charge amount is predicted, and the potential forming condition for image creation is set such that density of the normal image becomes constant. This makes it possible to reduce variation in the image density occurring on a short-term basis. Therefore, it is possible to perform stabilization of image density both on a short-term basis and a long-term basis in a compatible manner.

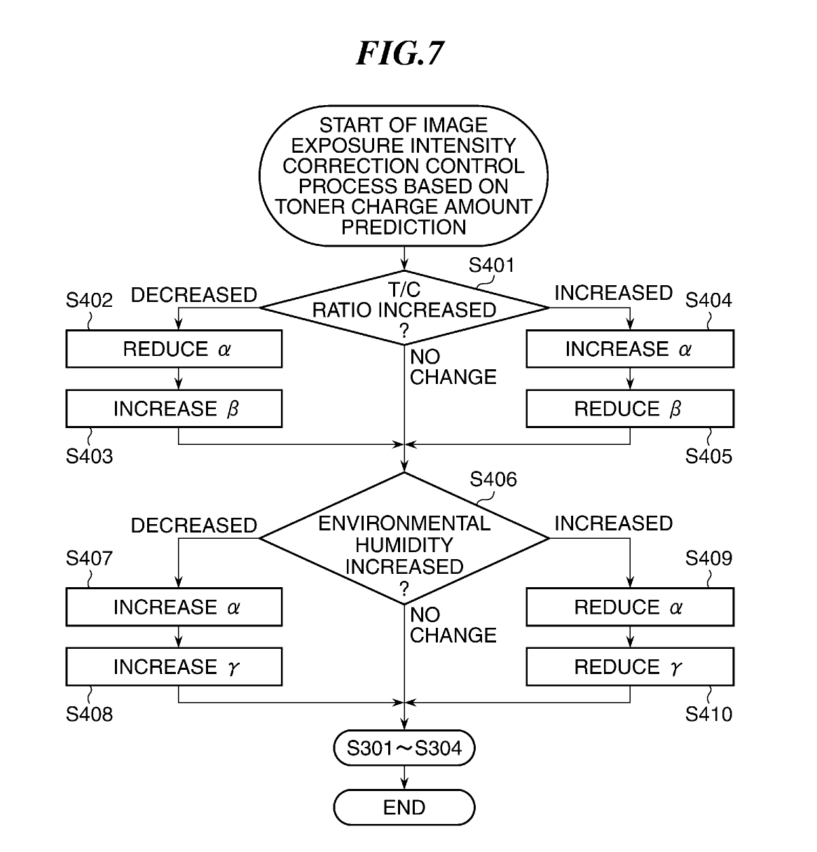

Next, an image forming apparatus according to a second embodiment of the present invention will be described with reference to FIG. 7. The second embodiment differs from the first embodiment in the image exposure intensity correction control process based on the prediction of the toner particle charge amount. Therefore, a description will be given of the second embodiment with reference to FIG. 7 in place of FIG. 5. The second embodiment differs from the first embodiment only in addition of control for changing the parameters α and β based on the T/C ratio, and changing the parameters α and γ based on the environmental humidity within the main unit of the image forming apparatus in the above equations (1) and (2). The other part of the configuration and manners of control aspects of the present embodiment are identical to those of the first embodiment, and hence a description thereof is omitted, but only different points are described, while denoting component elements corresponding to those of the first embodiment by identical reference numerals. The CPU 2 causes output values from the T/C ratio-detecting sensor 16 (values averaged over time periods in respective time steps) and detection values from the temperature and humidity sensor 17 (particularly, values of environmental humidity) to be stored in the RAM 11.

FIG. 7 is a flowchart of the image exposure intensity correction control process based on the prediction of the amount of electrostatic charge of toner particles, which is executed by the image forming apparatus according to the second embodiment.

The CPU 2 determines based on an output value from the T/C ratio-detecting sensor 16 whether or not the T/C ratio has increased (step S401). As a result of the determination, if the T/C ratio has decreased, the CPU 2 reduces the value of α (step S402) in the above equation (1), and increases the value of β in the above equation (1) (step S403). On the other hand, if the T/C ratio has increased, the CPU 2 increases the value of α (step S404) in the above equation (1), and reduces the value of β (step S405) in the equation (1). If there is no change in the T/C ratio, the CPU 2 changes neither the value of α nor that of β.

Next, the CPU 2 determines based on a detection value from the temperature and humidity sensor 17 whether or not the environmental humidity has become higher than before (step S406). As a result of the determination, if the environmental humidity has increased, the CPU 2 reduces the value of α in the above equation (1) (step S409), and reduces the value of γ in the equation (2) (step S410). On the other hand, if the environmental humidity has decreased, the CPU 2 increases the value of α in the above equation (1) (step S407), and increases the value of γ in the above equation (2) (step S408). If there is no change in the environmental humidity, the CPU 2 changes neither the value of α nor that of γ.

More specifically, when the T/C ratio has increased, the CPU 2 changes the parameters in a direction in which the calculated value of the toner particle charge amount (predicted value) is reduced. Further, when the environmental humidity has increased, the CPU 2 changes the parameters in a direction in which the calculated value of the rate of frictional charging (elimination of electrostatic charge) per unit time is reduced. Alternatively, when the environmental humidity has increased, the CPU 2 may change the parameters in a direction in which the toner particle charge amount (predicted value) is reduced.

Thereafter, the CPU 2 executes the same processing as executed in the steps S301 to S304 in FIG. 5, followed by terminating the present process.

Although the saturated toner particle charge amount, the rate of friction charging (elimination of electrostatic charge) per unit time, and the rate of charge leakage from toner particles per unit time vary with the T/C ratio and the environmental humidity, it is possible to properly adjust these parameters by executing the steps S401 to S410. By performing this adjustment, it is possible to perform prediction of the toner particle charge amount with accuracy in response to changes in the change characteristics, even when the environment in which the image forming apparatus is installed changes, causing changes in the change characteristics of the toner charge amount. This improves accuracy in the image exposure intensity correction control.

Therefore, according to the present embodiment, it is possible to obtain the same advantageous effects as provided by the first embodiment, and particularly, it is possible to improve the accuracy in the feedforward control based on the prediction of the toner particle charge amount, and thereby makes it possible to effectively reduce variation in the image density on a short-term basis.

It should be noted that for correction of the parameters, only one of the T/C ratio and the environmental humidity may be employed.

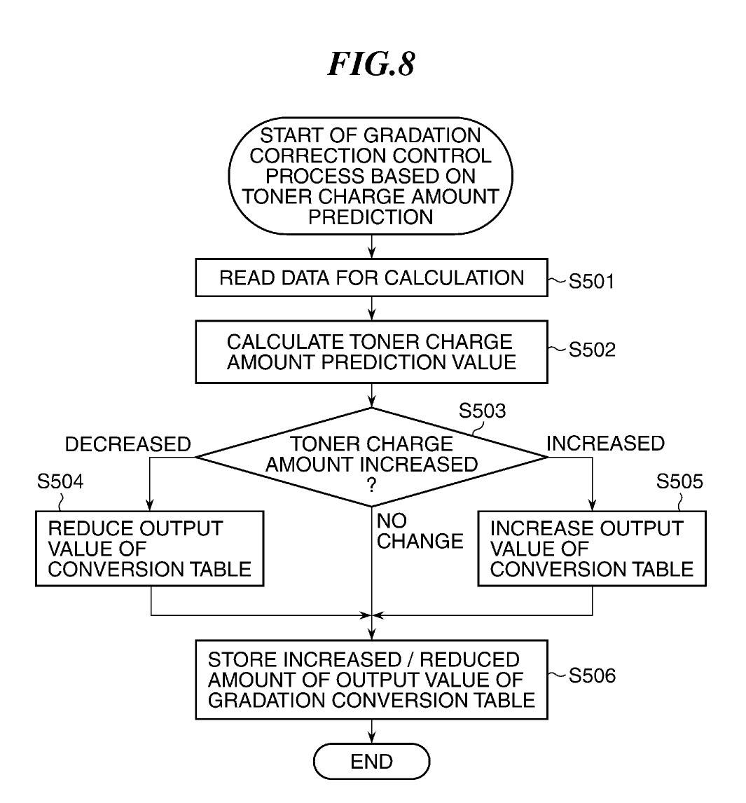

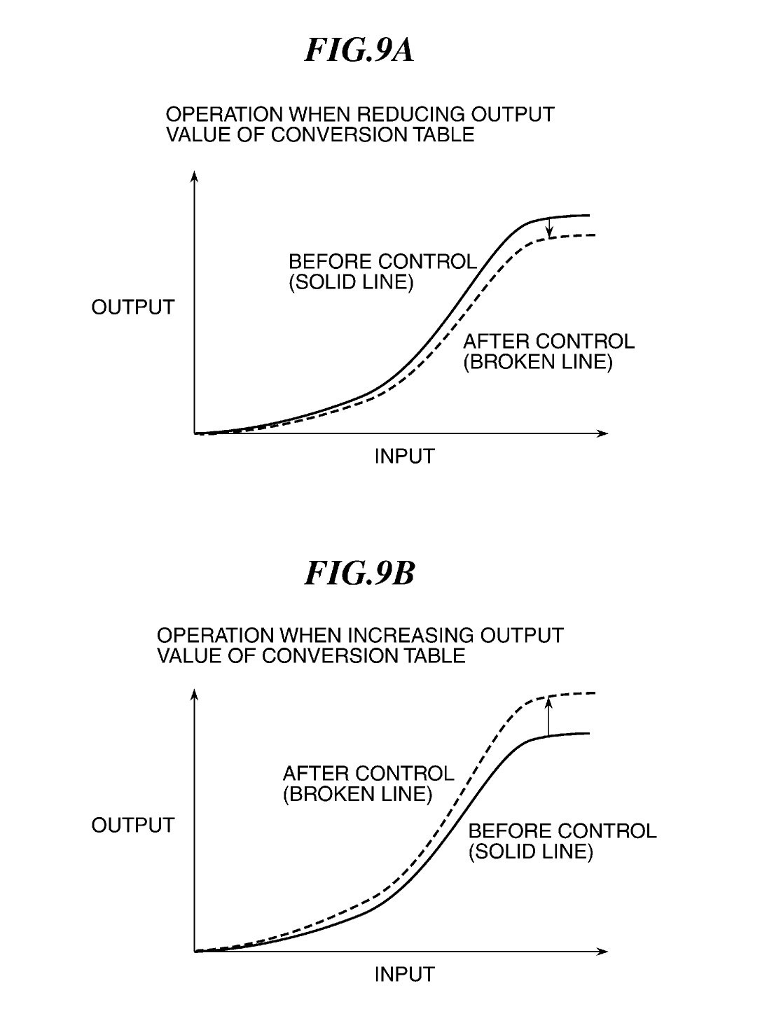

Next, an image forming apparatus according to a third embodiment of the present invention will be described with reference to FIGS. 8 to 9B. In the above-described first embodiment, the correction control based on the prediction of a toner particle charge amount is applied to the laser power correction amount at the time of normal image output. However, the third embodiment differs from the first embodiment in that the correction control based on the prediction of a toner particle charge amount is applied to the gradation conversion table. The other part of the configuration and manners of control aspects of the present embodiment are identical to those of the first embodiment, and hence a description thereof is omitted, but only different points are described, while denoting component elements corresponding to those of the first embodiment by identical reference numerals. The gradation-converting unit 18 (see FIG. 1) is controlled to reduce changes in the predicted toner charge amount, i.e. predicted changes in density. The gradation conversion based on the prediction of an amount of electrostatic charge of toner particles is not applied to an image patch formed in the toner replenishment adjustment amount feedback control for maintaining the amount of electrostatic charge of toner particles at a constant amount. Therefore, a description will be given of the third embodiment with reference to FIG. 8 in place of FIGS. 5 and 6, and further with reference to FIGS. 9A and 9B.

FIG. 8 is a flowchart of a gradation correction control process based on the prediction of a toner particle charge amount, which is executed by the image forming apparatus according to the third embodiment. The process in FIG. 8 is executed in a manner inserted between the step S104 and S107 in place of the steps S105 and 106 in FIG. 2.

In steps S501 and S502 in FIG. 8, the CPU 2 executes the same processing as executed in the steps S301 and S302 in FIG. 5. Next, in a step S503, the CPU 2 determines from a result of prediction of the amount of electrostatic charge of toner particles whether or not the amount of electrostatic charge of toner particles has increased. Then, based on the result of the determination, the CPU 2 increases or decreases a value of an output with respect to an input in the gradation conversion table stored in the RAM 11 (steps S504 and S505). This processing for increasing or decreasing the value of the output is executed by the gradation-converting unit 18 under the control of the CPU 2.

That is, when the amount of electrostatic charge of toner particles has decreased, the CPU 2 causes the value of the output to be reduced with respect to the input in the gradation conversion table (step S504). On the other hand, when the amount of electrostatic charge of toner particles has increased, the CPU 2 causes the value of the output to be increased with respect to the input in the gradation conversion table (step S505). Further, when there is no change the amount of electrostatic charge of toner particles, the CPU 2 holds the value of the output with respect to the input in the gradation conversion table as it is.

FIGS. 9A and 9B illustrate examples of cases where the value of the output in the gradation conversion table is reduced and increased, respectively. In a step S506 in FIG. 8, the CPU 2 causes an increased or reduced amount of the value of the output with respect to the input in the gradation conversion table to be stored in the RAM 11. More specifically, the CPU 2 stores data of table representation curves (indicated by broken lines), as shown in FIGS. 9A and 9B, which have been obtained by subjecting an original table representation curve (indicated by a solid line) to respective increasing and decreasing controls. Then, when a normal image is formed by the print job in the step S109 in FIG. 2, the stored data of the table representation curves is reflected on the output of gradation conversion. However, this control for increasing or reducing the value of the output is not applied to image patch formation in the step S204 in FIG. 3.

Here, a degree of increase or decrease of the output value is set by an amount dependent on the result of prediction of the amount of electrostatic charge of toner particles. However, this is not limitative, but any suitable amount can provide the same advantageous effects, insofar as it increases or decreases the output value in a direction in which variation in the density of the toner image is reduced when forming a toner image for normal image formation.

It should be noted that an object to be predicted is not limited to the toner charge amount, but it may be a more direct object, such as development toner density (toner output density). In that case, when the development toner density is predicted to increase, the value of output in the gradation conversion table is reduced, whereas when the development toner density is predicted to decrease, the value of output in the gradation conversion table is increased.

According to the third embodiment, it is possible to obtain the same advantageous effects as provided by the first embodiment concerning the stabilization of image density on a long-term basis. Further, the gradation correction based on the result of prediction of the amount of electrostatic charge of toner particles makes it possible to reduce variation in density due to changes in the amount of electrostatic charge of toner particles, which cannot be suppressed by the toner replenishment adjustment amount feedback control. Therefore, it is possible to perform both of stabilization of the image density on a short-term basis and that on a long-term basis in a compatible manner.

It should be noted that in the third embodiment, the steps S401 to S410 in FIG. 7 (correction of the values of α, β, and γ) in the second embodiment can be applied to the gradation correction control process based on the prediction of the toner particle charge amount in FIG. 8.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

### REFERENCE SIGNS LIST

1 image controller
2 CPU
5 photosensitive drum
9 developer container
16 T/C ratio-detecting sensor
20 optical sensor

1. An image forming apparatus that performs image formation by electrophotography, comprising:
a predicting unit configured to predict an amount of electrostatic charge of toner particles in a developer container;
a setting unit configured to set a potential forming condition for image creation;
an image creation unit configured to form a toner image to be fixed on a recording medium, on an image bearing member, according to the potential forming condition set by said setting unit;
a forming unit configured to form a pattern image for controlling a toner replenishment amount of toner to be supplied to the developer container for replenishment, on the image bearing member, under a potential forming condition which is set independently of the potential forming condition set by said setting unit for image creation;
a detection unit configured to detect density of the pattern image formed by said forming unit; and
a control unit configured to control the toner replenishment amount of toner to be supplied to the developer container such that the density of the pattern image, detected by said detection unit, becomes closer to a target density,
wherein said setting unit sets the potential forming condition for image creation based on a result of prediction by said predicting unit such that density of the toner image formed by said image creation unit becomes constant.

2. The image forming apparatus according to claim 1, wherein the potential forming condition set by said setting unit for image creation includes a condition of exposure intensity.

3. The image forming apparatus according to claim 1, wherein said predicting unit predicts the amount of electrostatic charge of toner particles based on an amount of toner supplied to the developer container for replenishment and an amount of toner consumed from the developer container.

4. The image forming apparatus according to claim 3, wherein said predicting unit further predicts the amount of electrostatic charge of toner particles based on a mixture ratio between toner particles and carrier particles in the developer container.

5. The image forming apparatus according to claim 3, wherein said predicting unit further predicts the amount of electrostatic charge of toner particles based on environmental humidity.

6. An image forming apparatus that performs image formation by electrophotography, comprising:
a predicting unit configured to predict an amount of electrostatic charge of toner particles in a developer container;
an image creation unit configured to form a toner image to be fixed on a recording medium, on an image bearing member;
a correction unit configured to perform gradation correction when the toner image is formed by said image creation unit;
a forming unit configured to form a pattern image for controlling a toner replenishment amount of toner to be supplied to the developer container for replenishment, on the image bearing member, while performing gradation correction which is not dependent on a result of prediction by said predicting unit;
a detection unit configured to detect density of the pattern image formed by said forming unit; and
a control unit configured to control the toner replenishment amount of toner to be supplied to the developer container such that the density of the pattern image, detected by said detection unit, becomes closer to a target density,
wherein said correction unit performs the gradation correction based on the result of the prediction such that the density of the toner image formed by said image creation unit becomes constant.

7. The image forming apparatus according to claim 6, wherein said predicting unit predicts the amount of electrostatic charge of toner particles based on an amount of toner supplied to the developer container for replenishment and an amount of toner consumed from the developer container.

8. The image forming apparatus according to claim 7, wherein said predicting unit further predicts the amount of electrostatic charge of toner particles based on a mixture ratio between toner particles and carrier particles in the developer container.

9. The image forming apparatus according to claim 7, wherein said predicting unit further predicts the amount of electrostatic charge of toner particles based on environmental humidity.
